(19) United States
(12) Patent Application Publication
(10) Pub. No.: US 2008/0122390 A1
(43) Pub. Date: May 29, 2008

(54) Systems and methods for the production of fluorine-18 using high current proton accelerators

(76) Inventor: Joseph Lidestri, New York, NY (US)

Correspondence Address: WilmerHale/Columbia University, 399 PARK AVENUE, NEW YORK, NY, 10022, US

(21) Appl. No.: 11/811,907

(22) Filed: Jun. 12, 2007

Related U.S. Application Data
(60) Provisional application No. 60/813,023, filed on Jun. 13, 2006.

(51) Int. Cl. H05H 7/00

(52) U.S. Cl. 315/501

(57) ABSTRACT

The disclosed subject matter provides a system for producing isotopes, such as fluorine-18, that includes a means for splitting a particle beam provided by a particle accelerator into a plurality of split beans and for directing the split beams onto a plurality of targets. In one embodiment, the means for splitting a particle beam is a dual charge beam splitter that receives a particle beam having a negative polarity and creates a single particle beam with a dual charge. In another embodiment, the means for splitting a particle beam is a single charge beam splitter.

### CROSS-REFERENCE TO RELATED APPLICATIONS

This application claims the benefit of U.S. Provisional Patent Application No. 60/813,023, filed on Jun. 13, 2006, which is hereby incorporated by reference herein in its entirety.

### TECHNOLOGY AREA

Systems and methods for the production of Fluorine-18 using high current proton accelerators are provided.

### BACKGROUND OF THE INVENTION

Short-lived radioisotopes such as Fluorine-18 (18F) are used in various biomedical applications such as Positron Emission Tomography (PET). These radioactive isotopes are typically produced using electrostatic, cyclotron or linear induction proton accelerators that provide a single particle beam used to produce isotopes one target at a time. Accordingly, there is a need for systems that use a single particle beam to produce isotopes on a larger scale.

### SUMMARY OF THE INVENTION

Generally speaking, the disclosed subject matter relates to particle accelerators. More particularly, the disclosed subject matter relates to proton accelerators, and isotopes and compositions produced therewith.

In some embodiments, a system for producing isotopes, such as Fluorine-18, is provided that includes a means for splitting a particle beam provided by a particle accelerator into a plurality of split beams and for directing the split beams onto a plurality of targets. In one embodiment, the means for splitting a particle beam is a dual charge beam splitter that receives a particle beam having a negative polarity and creates a single particle beam with a dual charge. The dual charge beam splitter may include a first quadrupole magnet that expands the beam by defocusing it in one plane and focuses it in the orthogonal plane, a second quadrupole magnet that reestablishes paraxial particle trajectories, and a stripper grid allowing the negative beam to pass the grid such that part of the beam loses its electrons while part of the beam retains its electrons. In another embodiment, the means for splitting a particle beam is a single charge beam splitter that includes a pair of quadrupole magnets to focus the particle beam in two planes and a deflection magnet for directing the beam onto the targets.

Additional aspects of the disclosed subject matter will be apparent in view of the description that follows.

### BRIEF DESCRIPTION OF THE DRAWINGS

FIG. 1 is a flowchart illustrating the glycolytic pathway.

FIG. 2 is a diagram of glucose and glucose 6-phosphorate.

FIG. 3 is a diagram illustrating the development of 18F FDG synthesis.

FIG. 4 is a diagram illustrating efficient stereospecific synthesis of FDG.

FIG. 5 is a diagram of an automated system for FDG synthesis.

FIG. 6 is a view of a particle beam target.

FIG. 7 is a diagram of a dual charge beam splitter in accordance with some embodiments of the disclosed subject matter.

FIG. 8 is a diagram of a single charge beam splitter in accordance with some embodiments of the disclosed subject matter.

### DETAILED DESCRIPTION OF THE INVENTION

The disclosed subject matter generally provides methods and systems that increase the rate and efficiency with which isotopes are produced, and isotopes and compositions produced therewith. The disclosed subject matter generally increases production/efficiency by splitting up a single particle beam extracted from a single high current particle accelerator into multiple beams that can be used on multiple targets, simultaneously or otherwise, to produce isotopes therewith. Although the disclosed subject matter may be described by way of example with respect to 18F production for use in the synthesis of 2-Deoxy-2-[18F]Fluoro-D-Glucose (FDG), the disclosed subject matter is generally applicable for the production of other isotopes and for the production of other compositions, and is thus not limited thereto. FDG is the primary pharmaceutical used as the glucose (C6-H12-06) metabolism tracer in positron emission tomography (PET) imaging.

The metabolism of glucose involves the formation of adenosine triphosphate (ATP) through series of chemical reactions. ATP is a molecular unit that transports chemical energy between various metabolic pathways. The formation of ATP from glucose can be organized into three stages. Stage 1, where acetyl coenzyme A (C25-H38-N-7-0,7-P3-S) is produced by oxidative decarboxylation of pyruvate. Stage 2 where acetyl coenzyme A enters the Krebs cycle for oxidation in which electrons are removed in four steps. Stage 3 where the electrons are transferred and ATP is synthesized by processing phosphorylation.

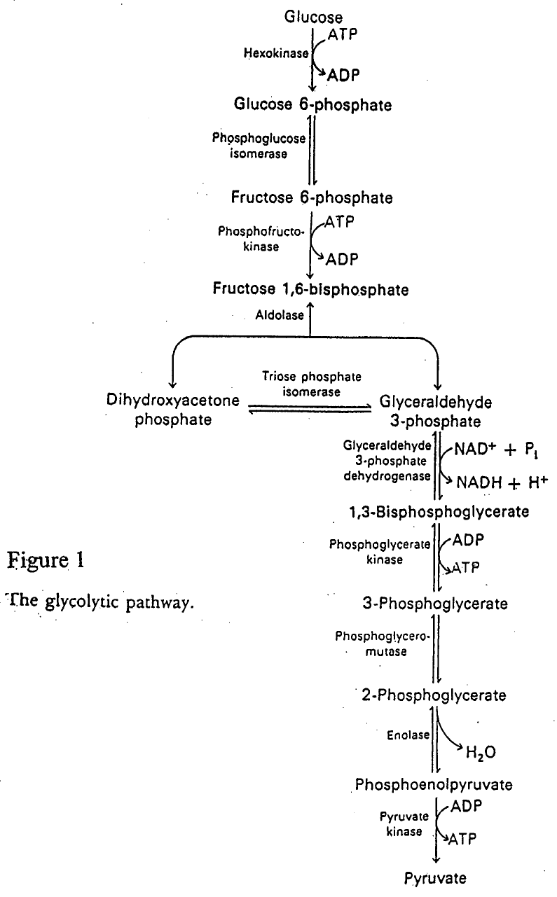

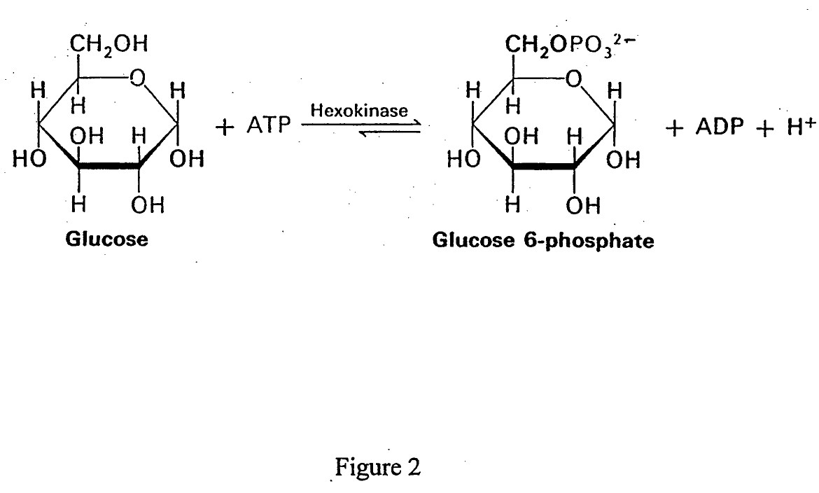

The catabolic formation of the pyruvate in Stage 1 is referred to as glycolysis and shown in FIG. 1 where a molecule of glucose is broken down into two molecules of pyruvate. Shown in FIG. 2 is the first reaction of this pathway where glucose is phosphorylated by ATP to form glucose 6-phosphate. Phosphoryation is catalyzed by hexokinase where a phosphoryl group from ATP is transferred to a six carbon sugar. FDG specifically isolates this hexokinase reaction. It is important to note that 23 years before the first synthesis of radio labeled FDG Sols and Crane discovered the specificity of 2-deoxyglucose for hexokinase. Their observations are summarized in the following quote.

“2-deoxyglucose possesses distinct advantages over glucose as a substrate for experimental studies with crude preparations of brain and other tissue hexokinases. The phosphate ester formed from 2-deoxyglucose is not inhibitory and it is not a substrate for either phosphohexoseisomerase or glucose-6-phosphate dehydrogenase. Thus, the use of 2-deoxyglucose isolates the hexokinase reaction.”

This well characterized understanding of the specific isolation of the hexokinase reaction with 2-deoxyglucose is the reason why FDG is the primary pharmaceutical used in PET imaging to trace glucose metabolism. Along the 24 years of PET scanner development, FDG studies have thus become widespread as a clinical diagnostic, which explains the increasing demand for 18F.

The development of a radiopharmaceutical generally starts by identifying a substrate that has a well characterized biochemical pathway such as the 2-deoxyglucose pathway described above. Next a chemical process is developed that can be used to synthesize a tracer compound from the substrate and a radio label with a decay scheme suitable for the nuclear medicine measurement of interest. In the case of PET imaging, nuclides with positron decay products can be used. Common positron emitters used in nuclear medicine are listed in Table A below with their half-life and decay products.

TABLE A

| Nuclide | Half life | | Decay-product |
|---|---|---|---|
| 18 F | 109 | min | 18 O |
| 15 O | 124 | s | 15 N |
| 13 N | 10 | min | 13 C |
| 11 C | 20 | min | 11 B |
| 82 Rb | 76 | s | 82 Kr |

### Chemical Synthesis of 18F-fluorodeoxyglucose (FDG)

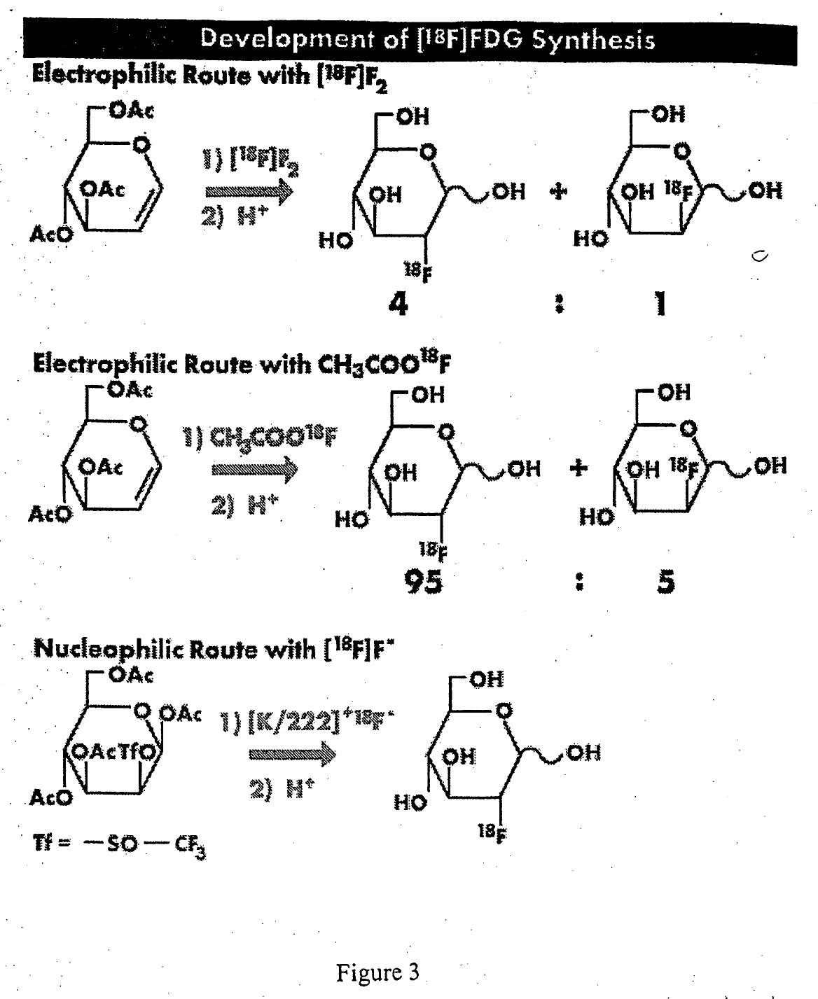

Two methods used to synthesis FDG include electrophilic addition and nucleophilic substitution. The process of electrophilic addition involves the addition of an electrophilic reagent to a substrate. In this process the electron deficient reagent has a strong tendency to accept electrons from the electron rich substrate. Typically the substrate acts as a base where carbon double bonds serve as a source of electron and the electrophilic reagent acts as an acid. FDG synthesis can be used for the electrophilic fluorination of glucal with the electrophilic reagent [18F]F2. This addition yields [18F]FDG and its 2-epimer in the ratio of 4:1. Stereo specificity can be improved by using acetyl-[18F]hypofluororite as the fluorination reagent. This addition yields [18F]FDG and 2-deoxy-2-[18F]fluoro-D-mannose (FDM) in the ratio of 95:1. These two electrophilic routes are summarized in FIG. 3 along with the nucleophilic route that has largely replaced the electrophilic route.

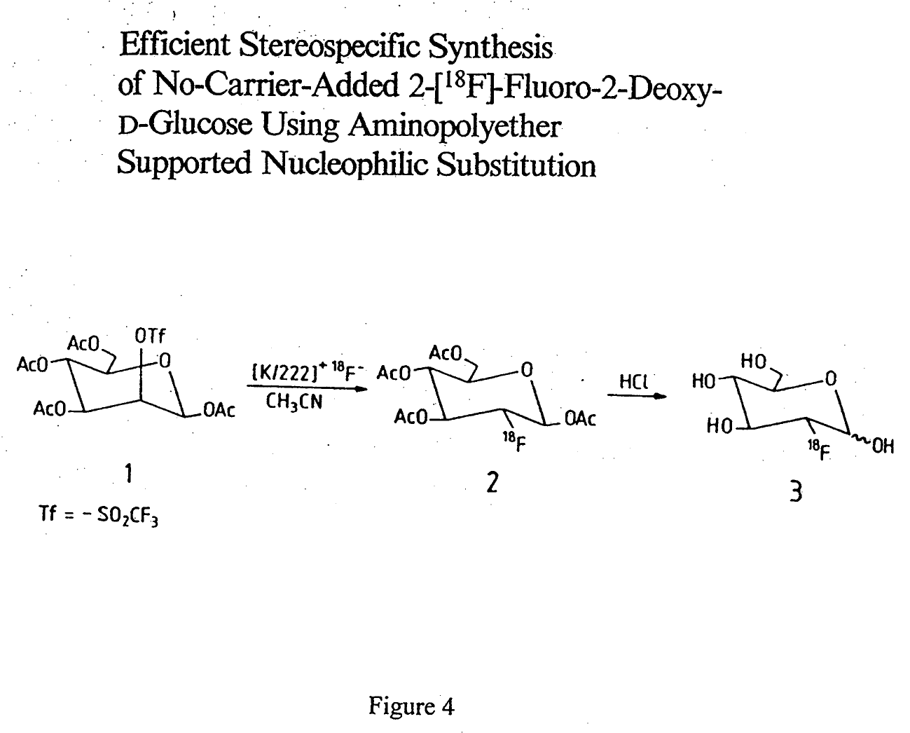

The process of nucleophilic substitution involves the substitution of part of the substrate with part of a nucleophilic reagent. In this process the electron rich reagent has a strong tendency to donate electrons to the electron deficient nucleus of the substrate. The carbon compound on which substitution takes place is the substrate and is characterized by the presence of a leaving group. After substitution, the leaving group departs from the molecule with a pair of electrons. Nucleophilic fluorination using the aminopolyether Kryptofix [2.2.2] to increase the reactivity of the fluoride ion results in epimerically pure and higher yields. This synthesis route, which is particularly useful for automated synthesis, is shown in FIG. 4. Nucleophilic fluorination starts with the tetraacetylated-D-mannose, i.e., 1,3,4,6-tetra-O-acetyl-2-trifluor-methanesulfonyl-B-D-mannopyranose as a precursor, and the aminopolyether potassium complex [K/2.2.2]+[18F-] as a phase-transfer catalyst. By using the tetraacetylated precursor the removal of the protecting groups can be carried out rapidly resulting in higher yields of 2-FDG.

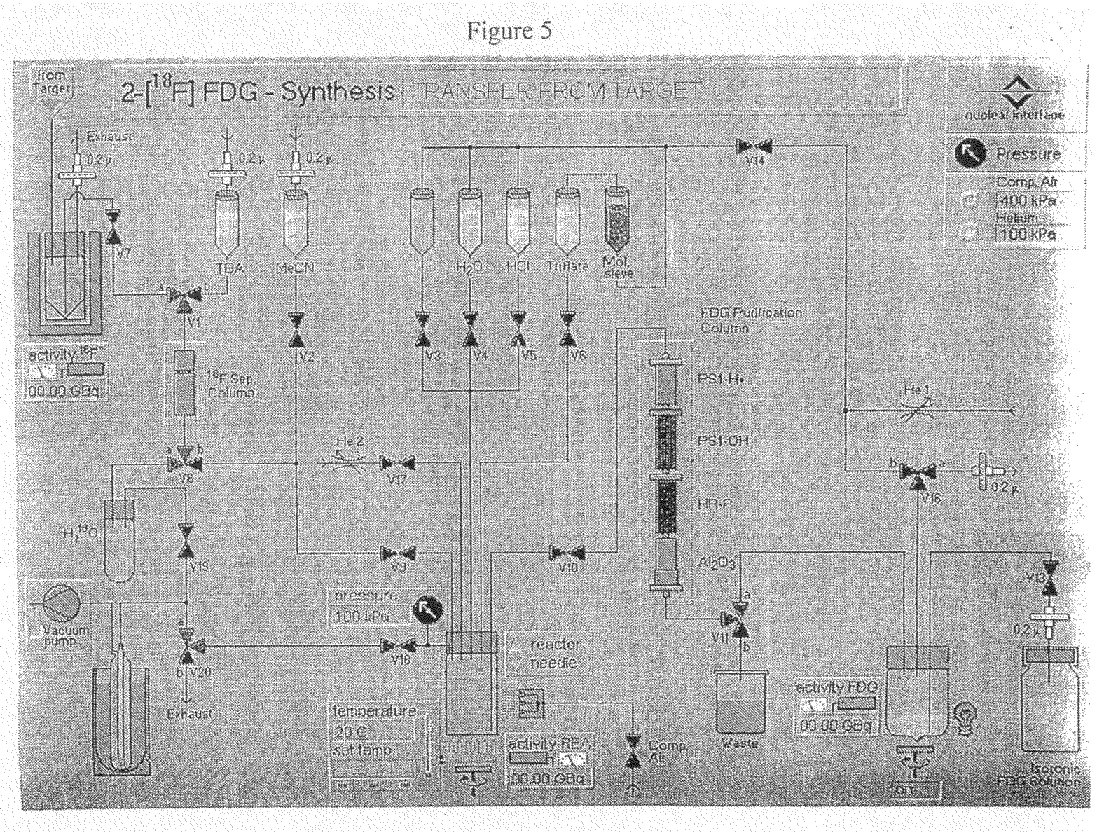

Because of the simplicity in substrate preparation and efficient stereo specific yields of 2-FDG, this nucleophilic process can drive automated microprocessor controlled synthesis units or systems, such as the automated PC controlled system is shown in FIG. 5. The system can start synthesis by separating H2[180] from [18F]-fluoride using a disposable cartridge. Next the radiofluorination of 1,3,4,6-tetra-O-acetyl-2-trifluor-methanesulfonyl-B-D-mannopyranose can be carried out in acetonitrile utilized by Kryptofix for anion activation. The resulting 1,3,4,6-tetra-0-acetyl-2-[18F]fluoro-D-glucopyranose is hydrolyzed. The labeled product is then purified by successive column technique producing an injectable solution. The typical synthesis time is 50 min.

### Nuclear Physics

Accelerator driven isotope production involves the transmutation of a target isotope into a product isotope via a nuclear reaction. The nuclear reaction is driven by bombarding the target with energetic particles typically protons, deuterons, or helium ions. The nuclear reaction typically results in the ejection of neutrons or alpha particles. The major physics issues include the decay scheme of the product isotope, the nuclear reaction cross-sections, and the energy deposition in the target. The most common accelerator produced PET isotopes (11C, 13N, 150, 18F) are listed in Table B with various targets and associated nuclear reactions.

TABLE B

| Target - Isotope | Nuclear - Reaction | Product - Isotope |
|---|---|---|
| 18O | p, n | 18F |
| 20Ne | d, a | 18F |
| 15N | p, n | 15O |
| 14N | d, n | 15O |
| 13C | p, n | 13N |
| 16O | a, n | 13N |
| 10B | | 13N |
| 14N | p, a | 11C |
| 11B | p, n | 11C |

### The general expressions for the nuclear reactions summarize above are as follows

| | | |
|---|---|---|
| A | X(p, n) Y | A |
| Z | | Z + 1 |
| A | X(p, a) Y | A − 3 |
| Z | | Z − 1 |
| A | X(d, a) Y | A − 2 |
| Z | | Z − 1 |

where X represents the target isotope and Y represents the product isotope.

The transmutation of the target isotope initiated by charged particles should take place when the bombarding particle energy exceeds the coulomb barrier height given by

$$B = \frac{{Zze}^{2}}{R}$$

where Z is the atomic number of the target, z is the atomic number of the bombarding particle, e is the elementary charge, and R is the nuclear radius.

The potential barrier is penetrated by particles with energies well below B because of wave mechanics. Because theoretical predictions of nuclear reactions are inadequate, well compiled cross sections can be used to determine the probability of an event occurring. The nuclear cross section is defined as

$$( nuclear cross section ) σ = \frac{a}{bc}$$

where a=# of processes occurring, b=# of incident particles, and c=# of target nuclei/cm².

The nuclear cross section for a reaction is defined in units of area. Traditionally the milli-barn (mb) is the unit used because a barn is approximately the area of nucleus (barn=10⁻²⁸ m²). When the cross section has the same area as the nucleus, the probability of the process occurring is one.

Cross Section data for nuclear reaction is available at national and international data centers. The national nuclear data center is at Brookhaven National Laboratory and contains Evaluated Nuclear Data File (ENDF). The cross sections plotted below are from Japanese Evaluated Nuclear Data Library Ver.3 (JENDL-3) available from the nuclear data center at JAERI (Japan Atomic Energy Research Institute). The plots attached hereto in Appendix A are the cross sections for nuclear products (11C, 13N, 15-O 18F). The cross sections are plotted as a function of on target proton energy and show that the probability of the producing (11C, 13N, 15-O) is highest when the proton energy is about 15 MeV and about 1 OMeV for producing 18F. Efficient isotope production should use proton energies that are near the peak cross section. Given an accelerator that can meet the proton energy requirement, the isotope production rate relies on the proton current capacity of the target.

### 18O Target for Producing 18F

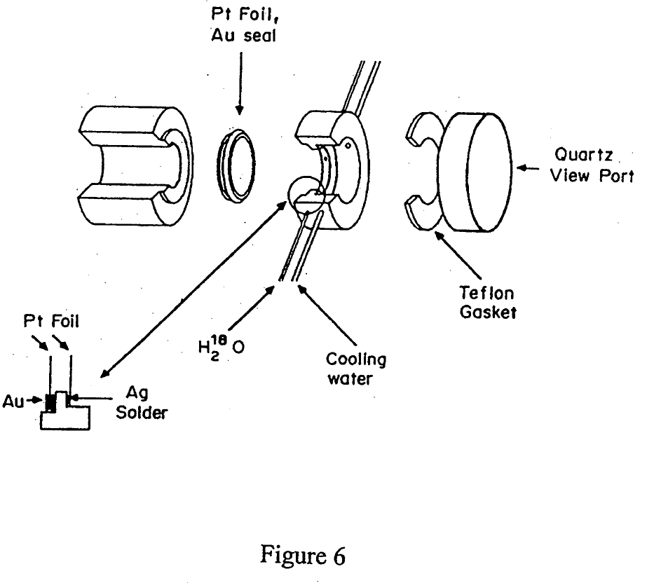

The stable isotope 18O used in the production of 18F is typically provided in the form of 18O-enriched water. The standard target geometry contains a small volume of 95 atom percent 18O water. The typical target volume is 800 ul and is limited to 40 ua of 10 MeV protons when the volume is isostatically pressurized to 600 psi. The volume is pressurized to inhibit the phase change to gas, which can be experienced at atmospheric pressure. The typical geometry used for a water target is in the shape of a thin metal disk as shown in FIG. 6. The primary issue in target design is the management of the heat generated from the Coulomb collisions and elastic collisions. The high energy proton transfers energy to the target as a result of the Coulomb collisions, which result in the ionization and excitation of atoms. Additionally energy is also transferred to recoiling atoms in elastic collisions. For protons, the sum of both the electronic and nuclear energy transfer in terms of energy loss per unit path length is called the Total stopping power.

The general equation for the stopping power is:

$$S ( E ) = - ( \frac{δ}{δ x} E ) = \frac{1}{4} \frac{{z}^{2} {e}^{2} {Z}^{2} ln ( - 2 {Im}_{0} {v}^{2} )}{{πɛ}_{0}^{2} {m}_{0}^{2} {v}^{2} A}$$

where I=ionization potential, Z=atomic number, x=distance, A=atomic mass, v=particle velocity, ze=particle charge, and m=electron mass.

The CSDA (continuous-slowing down approximation) range of a particle can be obtained by integrating the reciprocal of the total stopping power with respect to energy between 0 and E₀.

CSDA range=∫1/Sₜₒₜ(E)dE

Both stopping power and range tables for charged particles are available from the radiation dosimetry data base at the National Institute of Standards and Technology, Physics Laboratory. Ionizing Radiation Division. The data for total stopping power and range in water are plotted as a function of proton energy in Appendix B.

From this data, the range for a 1 OMeV proton in water is found to be 1.23 mm given the density of water is 1 gm/cm³. This means that all of the energy of a 1 OMeV proton is lost in the first 1.23 mm of the target volume. The energy deposition of 40 ua of 1 OMeV proton with a beam radius of 4 mm can cause a temperature rise of 300 deg C./sec. Since water is a bad conductor of heat, the energy deposited into the water needs to be convected out of the target volume. The target design can achieve a large temperature gradient by cooling the back of the target with water while cooling the front of the target with Helium. Because of the short proton range at this energy, targets are typically only 3-5 mm thick.

Various target cavity and foil metals can be used in target design to aid in the transfer of heat away from the target. Target cavities can be made of Silver or Titanium, which has the advantage of being chemically inert therefore avoiding reaction poisoning. The foils used in the front of the target can include Havar, Titanium, and Niobium. The energy lost in the foil by the entering proton beam is typically 500 KeV. As seen in the total stopping power curve in Appendix B, low energy protons have a much higher dE/dX than high energy protons. As a result, the rate of energy transfer of a proton at the end of its range is greater than at the beginning. This explains why a bragg peak is seen when dose is plotted as a function of depth. At some point in the protons track it will lose enough energy so not to be able to overcome the coulombic barrier. Appendix C shows an expanded plot of the cross sections for 0-18 (p, n) F-18 vs. proton energy.

From this plot we see a coulombic threshold of approximately 3 MeV. This means that when the incident 1 OMeV losses about 7 MeV, the nuclear reactions will nearly stop. The depth distribution of the nuclear reaction can be obtained from the total stopping power data. At present water target designs are power limited at a 40 ua of 1 OMeV protons. The disclosed subject matter uses multiple targets of proven design irradiated by multiple proton beams split from a single extracted high current beam. The beam splitting technique used depends on several beam characteristics, such as the beams time structure if pulsed and polarity of the extracted ion beam. The beam splitting technique must therefore be matched to the appropriate accelerator type. The following illustrates the various accelerator types appropriate for beam splitting in accordance with the disclosed subject matter.

### Proton Accelerator Concepts

Presently, particle accelerators used for isotope production make use of cyclotrons of various energy ranging from 3 MeV to 30 MeV. The three market groups for PET isotope producers include institutions that only have local in-house requirements, institutions that have both local in-house and remote distribution requirements, and industrial producers that have only remote distribution requirements. In the recent past (since 1984) the cyclotron has been highly developed specifically for in-house isotope production. Originally Cyclotron Corporation introduced the first turn key PET isotope cyclotron, the RDS-112. Quickly following the turn key approach, Scanditronix produced the PETtrace, Ion Beam Applications (IBA) produced the Cyclone series, and EBCO Technologies, Inc. produced the TR series. The newer LINAC technology as been developed more recently for isotope production by AccSys Technology, Inc. and LINAC Systems. The older electrostatic technology is presently being developed by PracSys and R. J. Nickles at University of Wisconsin.

Historically, the first accelerators used for nuclear physics were of the electrostatic type that produced only a few micro amps of current at moderate voltages. The three types of electrostatic accelerators include: a) transformer (non-resonant and resonant), b) cascade generators (DC voltage multiplier or Cockcroft Walton), and c) Van de Graaff (single ended and tandem). Electrostatic generators gave way to the cyclotron because of size requirements in scaling to higher voltages.

Recent developments by PracSys utilize a new transformer technology called Nested High Voltage Generator (NHVG). This new technology promises to produce 250 ua of 5 MeV Deuterons and Protons as well as 7.5 MeV Helium ions. The generator would be 14 ft long by 2 ft in diameter and have an efficiency of 25%. The key to achieving the generator's compact size is that only 2.5 MeV terminal voltage is required resulting from the generator's tandem geometry, such as that used by Van de Graaff accelerators. Particle acceleration starts by producing negative ions at ground potential and accelerating the ions to the center of the machine where a stripping foil is located at +2.5 MeV. When the negative ions pass through a stripping foil, the ions become positive accelerating back down to ground were the isotope target is located. The voltage gain after stripping depends on the charge of the ion since the energy E is given by the charge q times the gap voltage V. Since E=qV then for Deuterons and Protons where the charge is +1, after stripping another 2.5 MeV is added to the first 2.5 MeV acceleration. On the other hand the charge on Helium is +2 after stripping, so 5 MeV is added to the original 2.5 MeV. The moderate particle energies produced by this type of accelerator is associated with small nuclear reaction cross sections, but this simple transformer based concept can prove to be cost effective for small quantity production of the major PET isotopes. This concept in principle can be scaled to higher currents but only positive ion can be extracted.

The basic principle that made the cyclotron possible is the fact that an orbiting particle in a magnetic field takes the same time to make one revolution, regardless of radius or energy. Thus, the alternating voltage on the cyclotron's electrodes or dees can be set to match the revolution frequency of all the particles in the cyclotron. This is sometimes called the resonance condition because the accelerating force varies so as to always be in the direction of particle motion. Mathematically the particle revolution frequency can be derived as follows. A particle of mass in and charge q moving with speed v through a magnetic field of strength B feels a Lorentz force qvB bending it in a circle of radius r. From Newton's second law of motion we can set the mass in times the centripetal acceleration (v2/r) equal to the Lorentz force-toward the center to get mv²/r=gvB. The angular velocity (radians/second) is therefore w=v/r=qB/m. The revolution frequency (rev/second) is given by f=w/2 pi=qB/m2 pi and is referred to as the cyclotron frequency. The revolution frequency is thus independent of radius or energy. The particle will remain in step or in resonance with the constant frequency alternating voltage on the dees. Three types of cyclotrons based on this principle are a) conventional cyclotrons, b) synchrocyclotrons, and c) sector-focused cyclotrons

Conventional cyclotrons are limited to 10-20 MeV at which point the increasing relativistic mass of the ion reduces the revolution frequency causing the particle to gradually slip out of phase with the constant frequency accelerating voltage. Synchrocyclotrons are designed to exceed the energy limits of conventional cyclotrons by modulating the frequency of the accelerating voltage to keep the orbit phase synchronized. Another way to synchronize the orbit of a varying ion mass is to keep the frequency of the accelerating voltage fixed and pole shaping the magnet such that the field varies with radius. Sector focused cyclotrons use magnet pole faces that are sectioned which provides additional vertical focusing. This vertical focusing helps to increase the space charge limits of conventional cyclotrons. Original cyclotrons used for isotope production accelerated positive ions requiring a deflection channel for beam extraction to a target. This deflection extraction was only 70% efficient and required a lot of shielding do to the radiation generated at the deflector.

The newer negative ion cyclotrons are the industry standard today because acceleration of negative ion allows high efficiency extraction of the beam with a stripper foil. When the negative ion passes through a 5-25 um pyrolytic graphite foil, the ion changes polarity which in turn reverses the direction of the particle orbit with respect to the vertical field forcing the ion out of the dipole magnetic. Because of this extraction technique, which is typically used by manufacturers of PET isotope cyclotrons, only positive ions can be extracted on to a target. Some cyclotron manufacturers use internal ion sources and some use external sources. This turns out to be important for two reasons: higher quality source injection resulting in better overall beam quality, which is important when the beam is extracted on to a beam line, and using an external ion source improves the vacuum pressure in the accelerating dees, which results in less gas stripping and therefore less shielding. EBCO Technologies. Inc. manufactures the most versatile cyclotron, the TR 14. It uses an external ion source, and it can be upgraded from a TR 14 (200 ua of 14 MeV protons) to a TR 19 (2 ma of 19 MeV protons). It also has a beam emittance of 3 pi-mm-mrad. which is 3 times better than CTI, IBA, and GE.

Linear Induction Accelerators (LINAC) although new to the PET isotope field has a history dating back to 1928. There are two major types of LINACs: the radio frequency LINAC and induction LINAC. Both types can be designed to accelerate ions or electrons. The RF LINAC utilized standing wave or traveling wave structures while induction LINACs use sequentially pulse accelerating cells that function as lined up transformers. Induction LINACs have field patterns reversed of a betatron and produce the most intense particle beams with current as high as 20 kA. In contrast RF LINACs produce much less current than induction LINACs but can produce much more current than cyclotrons. RF LINACs utilize resonant structures to generate electric field patterns that impart accelerating forces in a constant direction. The most common of these structures is the washer loaded waveguide use to accelerate electrons. The washers slow the wave velocity down to keep the electric field in phase with the particle velocity of the electron. This type of structure can be designed for either the traveling or standing TM010 wave.

The three major accelerating structures used to accelerate ions are the radio frequency quadrupole (RFQ), the drift tube LINAC, and the radio frequency focused drift tube (RFD). The RFD is presently being developed for PET isotope production by LINAC Systems. This LINAC design would produce 120 ua of 12 MeV proton but is still in development. On the other hand the RFQ and the DTI are well proven technologies and have been used for many years in high energy particle accelerators. AccSys Technology Inc. uses a 2.3 m long RFQ to accelerate negative or positive ions from a 25 keV DC source to 3 MeV. The fields in the RFQ are such that the DC beam is focused, bunched and accelerated. This bunched 3 MeV beam is then injected into a 4 MeV DTL to produce a final 7 MeV beam with an average current of 150 ua. This beam has an emittance of 6 pi-mm-mrad and is made up of 20 ma pulses 150 us in width and has a pulse rate of 120 hz. The current of this LINAC can be upgrade to 1 ma and the energy can he increased with no limit by adding additional DTL modules. The standard 4 MeV DTL module has an accelerating gradient of 2.5 MeV/m. A unique feature of the LINAC is that either negative or positive protons can be extracted from the accelerator. This accelerator has the highest quality beam requiring the least about of radiation shielding in addition to having the intrinsic capacity to upgrade the original 7 MeV accelerator to higher currents and energy.

The present invention builds on particle accelerator technology by providing a multi-target beam splitter systems for use in, e.g., high current isotope production. A 10 fold increase in production of 18F can be achieved in accordance with the present invention by splitting single high current proton beam into a corresponding number of beams with each beam having a separate target, such the standard 40 ua water targets described above. If split ten ways, the total beam current required for 18F production would be about 400 ua. The two commercially available accelerators that can meet this current requirement are the EBCO TR 19 and the AccSys Technology, Inc. LINAC. The proton energy that best matches the cross section reviewed above is 14 MeV. Accordingly, 15 MeV will be used in the following illustrative examples to allow for vacuum and target foil losses.

The two major beam characteristics considered for beam splitting are the proton polarity and the beam time profile. In the case of the cyclotron, the extracted beam is limited to positive ions since a stripping foil is used for extraction. This cyclotron beam has a continuous beam current time profile. The LINAC can be designed to accelerate and extract both positive and negative protons that have a beam current time profile described above. The following examples utilize a 400 ua beam of protons that can be extracted from either of these two accelerators and that can be split into as much as 10 separate beams. It is understood that a fewer number splits can be created, e.g., in lower powered, accelerators, in order to achieve the desired result with the available power. Similarly, a larger number of splits can be created in higher powered accelerators.

Two different methods for splitting the beam are discussed herein: one using a dual charge geometry and one using a single charge geometry. Both systems utilize a beam deflecting force which can be imparted either electrostatically or magnetically. For brevity, the following examples use magnetic deflection.

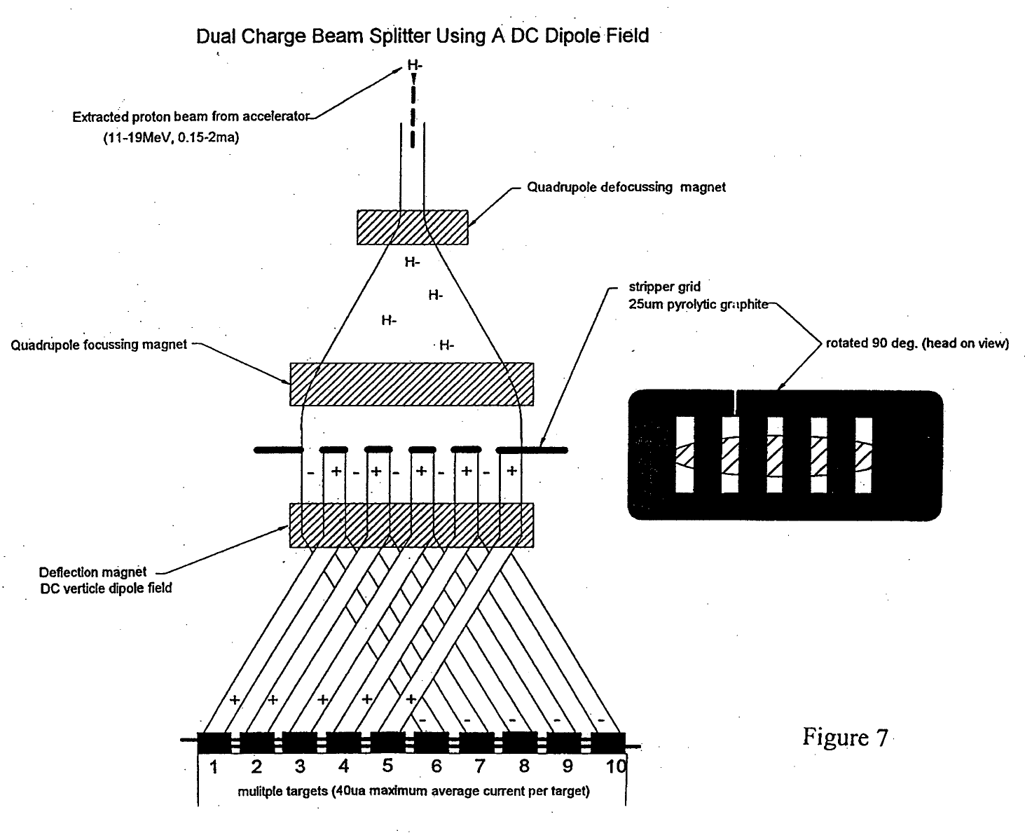

The dual charge beam splitter, as shown in FIG. 7, relies on a beam of negative polarity which is past through a stripper grid to create a single beam with alternating positive and negative charge (dual charge). Since this system requires an extracted beam of negative protons, the LINAC is most easily used. This beam will therefore be made up of multiple pulses with an average current of 400 ua. Starting at the top, the negative ion beam is injected into a quadrupole magnet that expands the beam by defocusing it in one plane and focuses it in the orthogonal plane. A second quadrupole magnet can be used to reestablish paraxial particle trajectories before entering the stripper grid. This quadrupole magnet could also be used to control the size of the beams after splitting. The beam is then passed thru the stripper grid and, as the negative beam passes the grid, part of the beam looses its electrons while part of the beam retains its electron. This beam with alternating positive and negative charge can then be deflected by a magnet that has a DC vertical dipole field. From the Lorentz force law, F=q(E+vXB), the direction of the force depends on the polarity of the charge so the positive charge goes to the left and the negative charge goes to the right for a dipole in the direction out of the page. The amount of beam separation is controlled by the strength of dipole field, which can be estimated from the Larmor radius that defines the orbit of a charged particle in a magnetic field. The following expression for the Larmor radius is derived by setting the Lorentz force equal to the centripetal force,

$$Larmor radius = ρ = \frac{βγ m c}{eB}$$

where m is the particle mass, c is the speed of light, e is a unit charge, B is the magnetic flux density and β=v/c and γ=1/(square root(1−β²)). Given a 15 MeV proton in a 2 Tesla magnetic field the Larmor radius is 0.2807 m. The deflection angle is approximately given by θ (radians)=1/p, where I is the integrated length of the magnet. Therefore 3.56 radians of deflection can be achieved per meter length at 2 Tesla with 15 MeV protons. A 10 cm long magnet would provide 20 deg. of deflection for each of the ten beams.

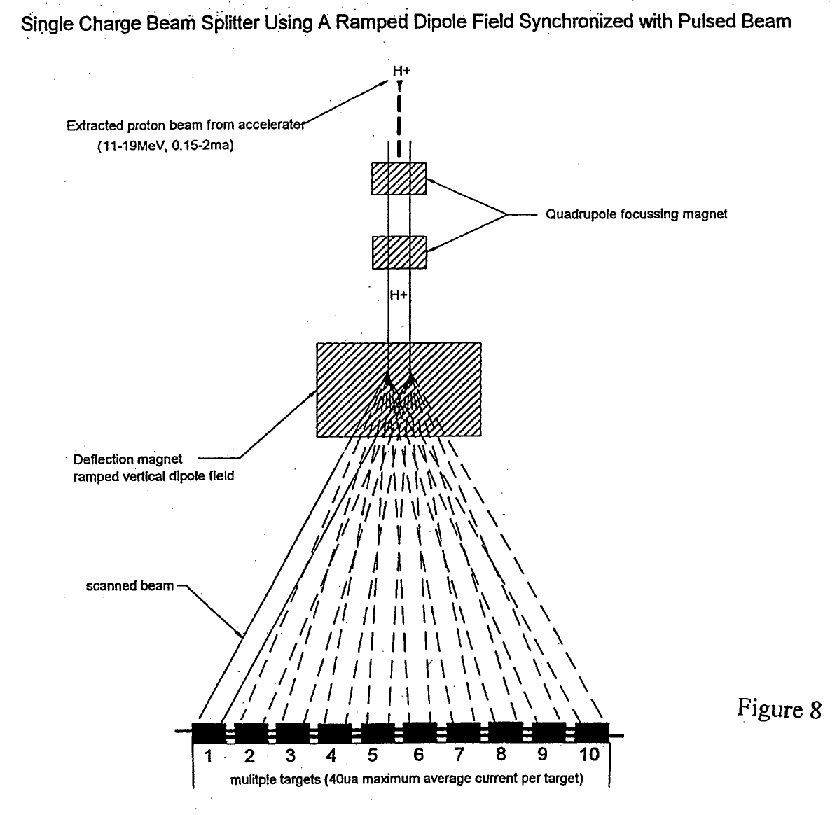

A single charge beam splitter, as shown in FIG. 8. splits the beam using dipole field with equivalent strength B as used above but instead of the field being constant, the field would be a repetitive ramp froth −B/2 to +B/2 with a repetition rate of 10 Hz. In this concept the proton beam can be a single charge of either positive or negative, but the beam must be pulsed for synchronization with the repetitive ramping dipole field. In this instance, the beam is first injected into a pair of quadrupole magnets to provide some focussing in both planes before entering the deflection magnet. Once the beam enters the deflecting magnet the beam can be directed to one of the ten targets depending on where the field is on the ramp. To achieve a Bi-directional scan the field would rump from −B/2 to +B/2. During this 100 ms ramp the proton accelerator would need to deliver 10 current pulses each being 5 ms wide and having a peak current of 8 ma each. The average beam current is given as I_{avg}=Iₚₑₐₖ T_{pulse width} f_{rep rate}. This results in an average beam current of 400 ua, which is divided up between 10 targets yielding 40 ua per target. This approach can be applied to LINAC beam or a Cyclotron beam. Using a LINAC would require the deflecting time history to be synchronized to the existing beam time history. Using a Cyclotron would require gating the ion source for synchronization. This can easily be done with Cyclotrons using external ion sources.

While the foregoing invention has been described in some detail for purposes of clarity and understanding, it will be appreciated by one skilled in the art, from a reading of the disclosure, that various changes in form and detail can be made without departing from the true scope of the invention in the appended claims.

What is claimed is:

1. A system for isotope production comprising means for splitting a particle beam provided by a particle accelerator into a plurality of split beams and for directing the split beams onto a plurality of targets.

2. The system of claim 1, wherein the split beams are directed toward a target for the production of fluorine-18.

3. The system of claim 1, wherein means for splitting a particle beam comprises a dual charge beam splitter that receives a particle beam having a negative polarity and creates a single particle beam with a dual charge.

4. The system of claim 1, wherein means for splitting a particle beam comprises a dual charge beam splitter comprising:
a first quadrupole magnet that expands the beam by defocusing it in one plane and focuses it in the orthogonal plane;
a second quadrupole magnet that reestablish paraxial particle trajectories; and
a stripper grid allowing the negative beam to pass the grid such that part of the beam looses its electrons while part of the beam retains its electron.

5. The system of claim 1. wherein means for splitting a particle beam comprises a single charge beam splitter comprising:
a pair of quadrupole magnets to focus the particle beam in two planes; and
a deflection magnet for directing the beam onto the targets.
